(19) United States
(12) Patent Application Publication
(10) Pub. No.: US 2003/0055765 A1
(43) Pub. Date: Mar. 20, 2003

(54) Financial portfolio risk management

(76) Inventor: Mark Bernhardt, Surrey (GB)

Correspondence Address: NIXON & VANDERHYE P.C., 8th Floor, 1100 North Glebe Road, Arlington, VA, 22201, US

(21) Appl. No.: 10/178,784

(22) Filed: Jun. 25, 2002

(30) Foreign Application Priority Data
Jun. 25, 2001 (GB) 0115443.4

(51) Int. Cl. G06F 17/60

(52) U.S. Cl. 705/36

(57) ABSTRACT

A method for selecting a portfolio w consisting of N assets of prices p₁ each having a history of T+1 returns at time intervals i, (uncompounded returns over the previous t time steps) comprising the steps of;

a) defining a series of vectors {p₁, p₂ to p_{T+1}} to represent the price increments p for portfolio w for a given number of time steps t over a period T+1;

b) optionally removing any deterministic trends identified in step a);

c) calculating using support vector algorithms a linear combination of the vectors defined in step b), of maximal length and which is as near as possible perpendicular to each vector Pᵢ in the series for optimal alpha parameters between C⁻ and C⁺

d) defining the portfolio w by the expression:

$$w = \sum {α}_{i}^{*} {p}_{i}$$

Some suitable algorithms and constraints for the algorithms are proposed. The invention further comprises computer programs for performing the invention when installed on suitable computer systems, and computer readable data.

This invention relates to financial portfolio risk management and more particularly to methods for selecting a portfolio which meets pre-defined criteria for risk and/or return on investment based on historical performance data for a collation of financial equities.

The method conventionally used to assess the risks associated with a financial portfolio management is based on Markowitz' theory. This theory presumes price increments to be random Gaussian variables, the statistical properties of a collection of share price increments being describable by a multi-variate Gaussian distribution as detailed below:

The price of N investments at given instant in time, i, is described by vector pᵢ. The total wealth of a portfolio at time i is proportional to the inner (dot) product w.pᵢ. Determining a portfolio which satisfies some pre-defined risk/return compromise amounts to selecting a particular weight vector w. In order to do this, it is usual to consider the vector of returns between time periods, (p₁−pᵢ₋ₜ)/pᵢ₋ₜ, By deducting non-random trends and according a mean value of zero to vector p, the task is then to find a value for w such that w.p has a minimum variance. This can be expressed as:

$${w}_{i} = \frac{1}{Z} {\sum }_{j} {( {C}^{- 1} )}_{ij}$$

where C is the covariance matrix of the multi-variate Gaussian and Z is the normalisation factor expressed as:

$$Z = {\sum }_{ij} {( {C}^{- 1} )}_{ij}$$

The Markowitz approach is flawed for a number of reasons. Firstly, analysis has shown that price increments are not Gaussian in behaviour, they have “power law” tails which can lead to larger fluctuations in price than predicted by a Gaussian model. These “power law” tails can cause errors in the estimation of C which may result in over specialisation on apparently less volatile shares which do not, in fact, increase risk. In practice, price increments are not stationary, they have daily fluctuations as well as medium term correlations thus it is difficult to collate sufficient data to estimate C accurately, thus C may suffer noise which can lead to amplification of errors in the risk calculation. Another notable disadvantage of the Markowitz model is that it fails to distinguish positive fluctuations from negative fluctuations. In financial risk analysis, negative fluctuations (i.e. potential losses) are of far more interest than positive fluctuations (profit).

The present invention aims to provide novel methods for the calculation of risk associated with a financial portfolio which, at least in part, alleviates some of the problems and inaccuracies which the inventors have identified in the prior art methods.

In a first aspect, the invention provides a method for selecting a portfolio w consisting of N assets of prices pᵢ each having a history of T+1 returns at time intervals i, (uncompounded returns over the previous t time steps) comprising the steps of;

a) defining a series of vectors {P₁, P₂ to P_{T+1}} to represent the price increments p for portfolio w over a historic time period T at time intervals i;

b) optionally removing any deterministic trends identified in step a);

c) calculating using support vector algorithms a linear combination of the vectors defined in step a), of maximal length and which is as near as possible perpendicular to each vector pᵢ in the series for optimal alpha values between C⁻ and C⁺

d) defining the portfolio w by the expression:

$$w = \sum {α}_{i}^{*} {p}_{i}$$

In a second aspect the invention provides a method for selecting a portfolio w consisting of N assets of prices pᵢ each having a history of T+1 returns at time intervals i, (uncompounded returns over the previous t time steps) comprising the steps of;

a) defining a series of vectors {q₁, q₂ to q_{T+1}} to represent the time evolution of a price increment qᵢ for each asset in the portfolio;

b) optionally removing any deterministic trends identified in step a);

c) calculating using support vector algorithms a linear combination of the vectors defined in step a), of maximal length and which is as near as possible perpendicular to each vector qᵢ in the series for optimal alpha values;

d) determining from the solutions to step c), optimal solutions for a series of vectors αᵢ* where:

$$w = {\sum }_{i} {α}_{i}^{*} {q}_{i}$$

In a third aspect the invention provides a A method for selecting a portfolio w consisting of N assets of prices pᵢ each having a history of T+1 returns at time intervals i, (uncompounded returns over the previous t time steps) comprising the steps of;

a) defining a vector xᵢ of N returns on an asset pᵢ over a historic time period T at time intervals i;

b) select a minimum desired threshold return value r where

w.xᵢ−r+ξᵢ≧0

wherein ξᵢ are positive (non-zero) slack variables reflecting the amount the portfolio w historically fell short of the desired value of r;

c) optimise the problem in step b) by applying the Langrangian function

minmize

$$L = \frac{1}{2} {‖ w ‖}^{2} + \frac{C}{p} {\sum }_{i = 1}^{T} {ξ}_{i}^{p}$$

where ξ^{p} represents the non-zero slack variables of step b) to a power p and C is a weighting constant;

d) transforming the function of c) to the dual Langrangian and solving the quadratic programming problem for dual variables α where p=1 and/or p=2;

e) determining from the solutions to step d), a portfolio w where;

$$w = {\sum }_{l = 1}^{T} {α}_{i} {x}_{i}$$

Exemplary methods of this aspect of the invention are now described in greater detail.

The algorithms described here require the following data to be supplied as input.

A time-aligned historical price time series is defined for each of the N assets to be considered in the portfolio. The length (in time-steps) of these series is arbitrary and will be denoted by T+1. The time intervals i between the prices are also arbitrary, but are assumed equal. For the rest of this description it is assumed (without loss of generality) that they are daily prices—thus the term ‘daily’ can be replaced in the following by any other time interval.

A desired minimum threshold level of daily return is denoted r. This is the risk level, the algorithm minimises the amount and size of portfolio returns that have historically fallen below this level. Note that although this return is calculated daily, the algorithm can be adjusted to reflect the return over a longer time period (e.g. a week or a month), that is it is the (uncompounded) return over the previous t days until the present day.

A constant C which tells the algorithm how ‘strict’ to be about penalising the occasions when the return falls below the threshold r. A large value of C will result in a portfolio which achieves the desired risk control on the historical data, but which may not generalise well into the future. A lower value of C allows the return threshold violations to be greater, but can produce portfolios that are more robust (and typically more realistic) in the future.

An optional desired mean return for the portfolio R. If this is not specified then the algorithm will produce the least complex (equates to most diverse—see below) portfolio that optimises the risk constraint.

An optional prediction for the future mean returns of all the assets. If this is not available then the algorithm automatically uses the historical mean returns for the assets

The algorithm produces as its output a set of weights, one for each asset, which we denote by the vector w, which has dimension N. These weights may be negative, which simply means that the particular asset is ‘sold short’. Later we will impose the constraint that the sum of the elements of w is equal to unity. This is simply stating that we have made an investment of one unit in the portfolio and that it is relative to this unit investment at the start that any returns are measured.

During its operation the algorithm finds an optimal balance between minimising the risk of sharp falls in price (“drawdowns”) expressed through r, and producing a portfolio that has minimum complexity in the sense of the so-called VC-dimension (Vapnik Chervonenkis dimension). Minimisation of the complexity in this way produces portfolios that work well in the future as well as on the historical data. In this application the ‘minimum complexity’ portfolio in the absence of any other constraints on risk or return is simply to weight every asset equally, this is consistent with what one may intuitively decide in the absence of relevant data.

Description of Algorithm

Let pᵢ be the price of an asset at time i. From this we define the (uncompounded) return on this asset (over the period T=1 of t previous time steps) evaluated at time i from the formula (pᵢ−pᵢ₋ₜ)/Pᵢ₋ₜ. Let xᵢ be the vector of N returns (one for each asset in the portfolio) at time i. These vectors of historical return are the main quantity of interest. If, as is optional, a prediction for the future mean returns is available then the vectors x must be translated in a pre-processing step first. This translation is given by

xᵢ|→Xᵢ+λ−μ

where μ is the mean returns vector for the historical price data and λ is the vector of predicted future returns. If there is no available method to compute (or estimate) the future returns then the simplest assumption is λ=μ in which case no preprocessing is needed.

The algorithm is tasked to ensure that, as often as possible, at least the minimum threshold desired return r (over the period t) is achieved and that any downwards deviations from this are minimal. This can be expressed mathematically for the portfolio as

W·Xᵢ−r+ξᵢ≧0

where w is the vector of weights to be applied when apportioning investment between assets and ξᵢ are positive ‘slack’ variables that (when non-zero) measure the amount the portfolio fell short of this aim. In order that the ‘return’ be well defined it is necessary that the weights sum to a constant which we take to be unity, i.e.,

w·1=1

Where the boldface 1 represents a vector of all unit investments.

An optional additional constraint sets the overall mean level of return R on the portfolio. This is expressed as follows

$$\frac{1}{T} {\sum }_{i}^{T} w \cdot {x}_{i} = R$$

The actual optimisation problem to be solved is expressed in terms of a Lagrangian function, which must be minimised subject to the above constraints. This is

$$L = \frac{1}{2} {‖ w ‖}^{2} + \frac{C}{p} {\sum }_{i = 1}^{T} {ξ}_{i}^{p}$$

In this expression, the first term is the traditional SVM complexity control term, which minimises the length of w—which has the effect of maximising the margin (i.e. reducing the complexity) of the resulting solution. The second term adds up all the errors (measured by the non-zero slack variables to some power p, and is weighted by the pre-defined constant C which controls the trade-off between complexity and accuracy.

In this form the optimisation is hard to solve due to the form of the inequality constraint above. However if we restrict ourselves to p=2 (quadratic error penalty—optimal for Gaussian noise) or p=1 (linear error penalty—robust to non-Gaussian noise) then the problem can be transformed into its ‘Lagrangian Dual’. This is mathematically equivalent to the original problem, but is far easier to solve because of the very simple form the inequality constraint now takes. The transformation process is a well known mathematical technique which can be found in many books on quadratic programming. The actual optimisation of the dual problem can be carried out routinely using any of a number of commercial or free quadratic programming packages.

Carrying out the transformation to the dual problem leads to the following specifications for the two cases which we call the ‘linear penalty algorithm’ (p=1) and the ‘quadratic penalty algorithm’ (p=2). These are detailed below.

Linear Penalty Algorithm

Maximise (with respect to the dual variables αᵢ) the following quadratic Lagrangian

$$L = - \frac{1}{2} {\sum }_{i = 1}^{T} {\sum }_{j = 1}^{T} {α}_{i} {α}_{j} {x}_{i} \cdot {x}_{j} + r {\sum }_{i = 1}^{T} {α}_{i}$$

subject to the following constraints

0≦αᵢ≦C

where

$${\sum }_{i = 1}^{T} {m}_{i} {α}_{i} = 1$$

where mᵢ₌ₓᵢ·1

the optional portfolio return constraint becomes

$$\frac{1}{T} {\sum }_{i = 1}^{T} {q}_{i} {α}_{i} = R where {q}_{i} = {\sum }_{j = 1}^{T} {x}_{i} \cdot {x}_{j}$$

Having found the solution in terms of the dual variables αᵢ the optimal portfolio weight vector is given by

$$w = {\sum }_{i = 1}^{T} {α}_{i} {x}_{i}$$

Quadratic Penalty Algorithm

Maximise (with respect to the dual variables αᵢ) the following quadratic Lagrangian

$$L = - \frac{1}{2} {\sum }_{i = 1}^{T} {\sum }_{j = 1}^{T} {α}_{i} {α}_{j} ( {x}_{i} \cdot {x}_{j} + \frac{1}{C} {δ}_{ij} ) + r {\sum }_{i = 1}^{T} {α}_{i}$$

where δᵢⱼ is the usual Kronecker delta (equal to 1 for equal indices and 0 otherwise) subject to the following constraints

αᵢ≧0

$${\sum }_{i = 1}^{T} {m}_{i} {α}_{i} = 1$$

where mᵢ=xᵢ·1

the optional portfolio return constraints becomes

$$\frac{1}{T} {\sum }_{i = 1}^{T} {q}_{i} {α}_{i} = R where {q}_{i} = {\sum }_{j = 1}^{T} {x}_{i} \cdot {x}_{j}$$

Having found the solution in terns of the dual variables αᵢ the optimal portfolio weight vector is given by

$$w = {\sum }_{i = 1}^{T} {α}_{i} {x}_{i}$$

These algorithms are novel and differ in the factor r and the form of the equality constraint from previous SVM algorithms.

In the special case where no value for the mean return is provided, and the desired threshold r is set at zero, the portfolio may be defined as follows:

Algorithms 3 and 4

To describe these geometrically motivated algorithms we consider the fundamental data to be the collection {p₁,p₂, . . p_{T}} of N dimensional vectors (the price increments for the portfolio at a give time) as defined in the description of the classical Markowitz theory. This time we seek a vector w such that (informally) w·pᵢ is as small as possible for as many of the vectors p as possible. Since it is likely that N is a lot smaller than T it is possible to make use of the epsilon-insensitive regression SVM in order to generate a sparse representation of w. In practice this is unnecessary as in these SVMs the kernel is linear and the dimensionality N is probably less than a few hundred so w can be stored explicitly.

For this case, the primal Lagrangian is given by

Minimise

$$L = \frac{1}{2} {‖ w ‖}^{2} + {C}^{-} {\sum }_{i} {( {ξ}_{i}^{+} )}^{λ} + {C}^{-} {\sum }_{i} {( {ξ}_{i}^{-} )}^{λ}$$

subject to the constraints

w.1=1

w·pᵢ+ξᵢ≧0

ξ⁺ᵢ−w·pᵢ≧0

ξ⁺ᵢ≧0

ξ⁻ᵢ≧0

However the interpretation of the dual Lagrangians is now different

Case λ=2 [Algorithm 3]

The Lagrangian dual problem becomes

Maximise

$$L = - \frac{1}{2} {\sum }_{i = 1}^{l} {\sum }_{j = 1}^{l} {α}_{i} {α}_{j} [ {p}_{i} \cdot {p}_{j} + \frac{1}{{C}^{+} + {C}^{-}} {δ}_{ij} ]$$

subject to the constraint Σmᵢαᵢ=1, where mᵢ=xᵢ.1

As before the vector w is given in terms of the optimal parameters by

W=Σαᵢ*pᵢ

It is now this vector itself that describes the optimal portfolio. The meaning of this Lagrangian can be made clear by considering w^{T} Cw and noting that the covariance matrix C is given by

$$C = \frac{1}{L} {\sum }_{i} {p}_{i} ⊗ {p}_{i}$$

thus denoting Kᵢⱼ=pᵢ·pⱼ we see that w^{T} Cw∝α^{T}K²α—thus in the Lagrangian above, it turns out to be the square root of the covariance that is being used.

Case λ=1 [Algorithm 4]

We transform the above problem into its Lagrangian dual resulting in

Maximise

$$L = - \frac{1}{2} {\sum }_{i = 1}^{l} {\sum }_{j = 1}^{l} {α}_{i} {α}_{j} {p}_{i} \cdot {p}_{j}$$

subject to the constraints

−C⁻≦αᵢ≦C⁺

and Σmᵢαᵢ=1, where mᵢ=xⱼ.1

Once again the portfolio vector is given by

W=Σαᵢ*pᵢ

However extreme events (in time) are automatically identified as they have the corresponding

α*ᵢ=C⁺ or α*ᵢ=−C⁻

Thus in another aspect the invention is a method for selecting a portfolio w consisting of N assets of prices pᵢ each having a history of T+1 returns at time intervals i, (uncompounded returns over the previous t time steps) comprising the steps of;

a) defining a series of vectors {p₁, p₂ to p_{T}} to represent the price increments pᵢ for portfolio w for a given number of time steps i over a period T+1;

b) optionally removing any deterministic trends identified in step a);

c) calculating a linear combination of the vectors defined in step b), of maximal length and which is as near as possible perpendicular to each vector Pᵢ in the series applying the regression SVM algorithm;

$$L = \frac{1}{2} ‖ {w}^{2} ‖ + {C}^{+} {\sum }_{i} {( {ξ}_{i}^{+} )}^{λ} + {C}^{-} {\sum }_{i} {( {ξ}_{i}^{-} )}^{λ}$$

subject to the constraints

w.1=1, w·pᵢξ⁻₁≧0, ξ⁺ᵢ−w·pᵢ≧0, ξ⁺ᵢ≧0 and ξ⁻ᵢ≧0

d) implementing the SVM algorithm of step c) for λ=1 and/or λ=2 and transforming the solution into its Lagrangian dual; and

e) solving the solution to the Lagrangian dual of step d) for optimal alpha parameters between C⁻ and C⁺; and

f) defining the portfolio w by the expression

$$w = \sum {α}_{i}^{*} {p}_{i}$$

In accordance with another aspect the present invention provides a method for selecting a portfolio w consisting of N assets of prices pᵢ each having a history of T+1 returns at time intervals i, (uncompounded returns over the previous t time steps) comprising the steps of;

a) defining a series of vectors {q₁, q₂ to q_{T+1}} to represent the time evolution of a price increment for each asset in the portfolio;

b) optionally removing any deterministic trends identified in step a);

c) calculating a linear combination of the vectors defined in step a) of maximal length and which is as near as possible perpendicular to each vector qᵢ in the series;

d) determining from the solutions to step c), optimal solutions for a series of vectors αᵢ* where:

e) defining the portfolio w from

$$w = {\sum }_{i} {α}_{i}^{*} {q}_{i}$$

The method may conveniently be carried out by use of regression Support Vector Machine (SVM) algorithms. This method is particularly beneficial in that it permits the separation of the covariance matrix C into positive and negative fluctuations enabling independent control of the sensitivity of positive and negative errors in calculating the optimum value of the portfolio w.

Some exemplary means of performing the method are summarised below by way of illustration.

### EXAMPLE

In order to minimise the risk, it is necessary to choose w to try to minimise large fluctuations of w.p (we can treat negative and positive fluctuations separately in what follows).

In order to describe these algorithms we need to define some new quantities, but as before we always consider N financial assets over T timesteps:

Let the T+1 dimensional vectors {q₁, q₂, . . . ,q_{N}} describes the time history (over T+1 timesteps) of the price increments of the N assets—where any deterministic trends have been removed. Thus each vector now describes the time evolution of the price increments of one asset qᵢ. The novel aspect which allows the re-casting of this problem as an SVM is the assertion that: in order to minimise the risk we must find a linear combination of these vectors (of maximal length) which is as near to perpendicular as possible to each of them in turn.

Finding this linear combination can be written as a regression SVM preferably without a so-called “epsilon-insensitive” region. In this regression SVM the target yᵢ=0 for all i, which further simplifies the problem to:

Minimise

$$L = \frac{1}{2} ‖ {w}^{2} ‖ + {C}^{+} {\sum }_{i} {( {ξ}_{i}^{+} )}^{λ} + {C}^{-} {\sum }_{i} {( {ξ}_{i}^{-} )}^{λ}$$

subject to the constraints

w·qᵢ−ξᵢ⁻≧0

ξᵢ⁺−w·qᵢ≧0

ξᵢ⁺≧0

ξᵢ⁻≧0

Where ξᵢ⁺ and ξᵢ⁻ are positive ‘slack variables’ that measure the positive and negative errors. The constants C⁺ and C⁻ determine how hard we penalise positive (resp. negative) errors in the optimisation.

Of critical interest is the constant λ since this controls the functional form of the error penalisation. Two cases can be solved exactly λ=1 and λ=2, these are both discussed below.

Case λ=2 [Algorithm 1]

The above problem can be transformed into its Lagrangian dual resulting in expression of the problem as:

Maximise

$$L = - \frac{1}{2} {\sum }_{i = 1}^{l} {\sum }_{j = 1}^{l} {α}_{i} {α}_{j} [ {q}_{i} \cdot {q}_{j} + \frac{1}{{C}^{+} + {C}^{-}} {δ}_{ij} ]$$

subject to the constraint Σαᵢ=1.

We observe that since qᵢ, qⱼ is proportional to the i,j^{th} element of the covariance matrix it is easy to show that in the limit C^{±}−∞ we recover exactly the theory of Markowitz. This shows that for finite C^{±} we are less likely to be seduced by an outlier than using the classical approach—this is one of the key benefits of this approach.

The solution to this problem is in terms of a set of particular optimal values for the alpha parameters. Denoting these as α*ᵢ, the vector w which is (almost) orthogonal to all of the price increment vectors, is then given by the expression:

$$w = {\sum }_{i} {α}_{i}^{*} {q}_{i}$$

and these α*ᵢ values determine the relative amounts of the i^{th} asset in the portfolio. In other words the portfolio is the vector α*. The solution of this quadratic optimisation problem can be achieved through a number of well known algorithms.

Case λ=1 [Algorithm 2]

Transforming the above problem into its Lagrangian dual we arrive at the expression

Maximise

$$L = - \frac{1}{2} {\sum }_{i = 1}^{l} {\sum }_{j = 1}^{l} {α}_{i} {α}_{j} {q}_{i} \cdot {q}_{j}$$

subject to the constraints

−C⁻≦αᵢ≦C⁺ and Σαᵢ=1

thus we are able to control the sensitivity to positive and negative errors independently. This linear type of error term has been shown to work better for non-Gaussian noise such as that present in share price increments—thus it is anticipated that this will result in considerable improvements over the classical Markowitz theory.

The solution to this problem is in terms of a set of particular optimal values for the alpha parameters. Denoting these as α*ᵢ, the vector w which is (almost) orthogonal to all of the price increment vectors is then given by

$$w = {\sum }_{i} {α}_{i}^{*} {q}_{i}$$

and these α*ᵢ values determine the relative amounts of the i^{th} asset in the portfolio. In other words the portfolio is the vector α*. The solution of this quadratic optimisation problem can be achieved through a number of well known algorithms.

Exemplary methods of this aspect of the invention are now described in greater detail.

The methods of the invention are conveniently executed by a suitably configured computer program comprising computer readable code for operating a computer to perform one or more of the methods of the invention when installed in a suitable computing apparatus. The computer program may optionally be accessible on-line via a local network or via the Internet or may optionally be provided on a data carrier such as a computer readable magnetic or optical disk.

The methods of the invention may further comprise the steps of displaying the portfolio which has been calculated and/or accepting payment for purchasing the portfolio.

In another aspect, the invention provides a system for performing the aforementioned methods, the system comprising;

a computer;

a database accessible by the computer and comprising data including prices pᵢ of a plurality of assets and a history of returns on those assets over a known time period T+1 at time intervals i

interface means for permitting a user to access the computer and to input data selecting N assets from the data base;

software means resident on the computer for causing the computer to define a portfolio utilising the method of any of claims 1 to 9;

means for providing to the user a visual representation of the defined portfolio.

Optionally the computer is a server and comprises the database. Alternatively, the database may be provided on a server separate from the computer but accessible by the computer via a telecommunications network. In the latter alternative, there may be a plurality of computers each having access to the database server via a telecommunications network.

The interface means is conveniently provided in the form of conventional computer peripherals which may include any or all of; a keyboard; a computer mouse, tracker ball or touch sensitive panel; a graphical user interface, a touch sensitive display screen or voice recognition technology.

The means for providing a visual representation may be provided in the form of conventional computer peripherals which may include, without limitation a printer and/or a display monitor.

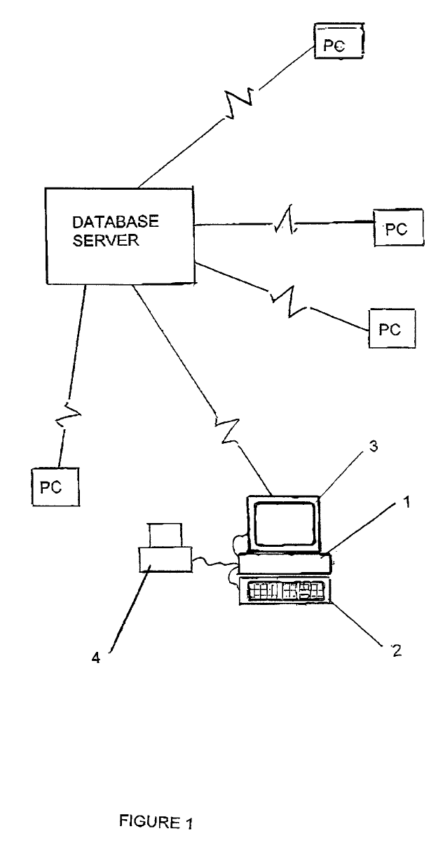

A representation of an embodiment of system in accordance with the invention is shown in FIG. 1.

As can be seen from FIG. 1, the system comprises a plurality of personal computer apparatus PC one of which is shown in more detail and comprises a computer processor (1), a keyboard (2) for interfacing with the processor, a display monitor (3) for displaying data from the processor (1) and a printer (4) for printing data from the processor (1). Each PC has access via telecommunication links (represented schematically in the figure by split lines) to a database server which contains the price data and historic returns data for a plurality of assets from which the user can select a quantity N, via his user interface (1,2,3,4) . Data relating to the N assets is downloaded from the server to a computer processor (1) which is programmed by software to define a portfolio w according to one or more of the previously described methods. Once defined, the portfolio can be displayed on the monitor (3) and/or a hard copy of the portfolio definition can be printed from printer (4)

An illustrative example of a method of one aspect of the invention is now given to demonstrate the potential improvement of accuracy in the method as against the prior art Markowitz approach.

Synthetic data was generated for 10 correlated financial assets The underlying probability density function for the price increments was taken as a ‘Student’ distribution with parameter d=6 giving power law tails of order O(x^{-7/2}) for individual assets (ensuring that the second moment is defined). The weighting coefficients were adjusted so that they summed to zero. For each time series 10⁵ samples were generated. An example of part of the time-series due to one of these assets is shown below. v,1-1/2

The assets were then combined into portfolios using the Markowitz algorithm and algorithm 1. In order to do this the first 50 points of each series were taken as ‘training data’. The time series for the combined portfolio was generated (over the whole data set) and histograms of the price increments of the portfolio obtained as a numerical approximation to its probability density function. These histograms are shown below using a logarithmic y-axis (probability) in order to show the differences in the tails of the distributions—which are most important for risk control.

As can be clearly seen the probability of large negative fluctuations is significantly reduced by using algorithm 1 relative to the classical Markowitz approach.

[image]

1. A method for selecting a portfolio w consisting of N assets of prices p₁ each having a history of T+1 returns at time intervals i, (uncompounded returns over the previous t time steps) comprising the steps of;
a) defining a series of vectors {p₁, p₂ to p_{T+1}} to represent the price increments p for portfolio w over a historic time period T at time intervals i;
b) optionally removing any deterministic trends identified in step a);
c) calculating using support vector algorithms a linear combination of the vectors defined in step a), of maximal length and which is as near as possible perpendicular to each vector pᵢ in the series for optimal alpha values between C⁻ and C⁺
d) defining the portfolio w by the expression:
$$w = \sum {α}_{i}^{*} {p}_{i}$$

2. A method for selecting a portfolio w consisting of N assets of prices pᵢ each having a history of T+1 returns at time intervals i, (uncompounded returns over the previous t time steps) comprising the steps of;
a) defining a series of vectors {q₁, q₂ to q_{T+1}} to represent the time evolution of a price increment q₁ for each asset in the portfolio;
b) optionally removing any deterministic trends identified in step a);
c) calculating using support vector algorithms a linear combination of the vectors defined in step a), of maximal length and which is as near as possible perpendicular to each vector qᵢ in the series for optimal alpha values;
d) determining from the solutions to step c), optimal solutions for a series of vectors αᵢ* where:
w=Σᵢaᵢ*qᵢ

3. A method as claimed in claim 1 wherein step c) involves;
i) applying the regression SVM algorithm;
Minimise
$$L = \frac{1}{2} ‖ {w}^{2} ‖ + {C}^{+} {\sum }_{i} {( {ξ}_{i}^{+} )}^{λ} + {C}^{-} {\sum }_{i} {( {ξ}_{i}^{-} )}^{λ}$$
subject to the constraints
w.1=1, w·pᵢ+ξ⁻ᵢ≧0, Σ⁺ᵢ−w·pᵢ≧0, ξ⁺ᵢ≧0 and ξ⁻ᵢ≧0
ii) implementing the SVM algorithm of step c) for λ=1 and/or ξ=2 and transforming the solution into its Lagrangian dual; and
iii) solving the solution to the Lagrangian dual of step ii) for optimal alpha values between C⁻ and C⁺.

4. A method as claimed in claim 2 wherein step c) involves;
i) applying the regression SVM algorithm;
Minimise
$$L = \frac{1}{2} ‖ {w}^{2} ‖ + {C}^{+} {\sum }_{i} {( {ξ}_{i}^{-} )}^{λ} + {C}^{-} {\sum }_{i} {( {ξ}_{i}^{-} )}^{λ}$$
subject to the constraints
w·qᵢ+ξ⁻ᵢ≧0, ξ⁺ᵢ−w.q₁≧0, ξ⁺ᵢ≧0 and ξ⁻ᵢ≧0
ii) implementing the SVM algorithm of step c) for λ=1 and/or λ=2 and transforming the solution into its Lagrangian dual; and
iii) solving the solution to the Lagrangian dual of step ii) for optimal alpha values between C⁻ and C⁺ subject to the constraint Σαᵢ=1.

5. A method as claimed in claim 3 wherein in step ii) the SYM algorithm is solved for λ=1.

6. A method as claimed in claim 4 wherein in step ii) the SVM algorithm is solved for λ=1.

7. A method for selecting a portfolio w consisting of N assets of prices pᵢ each having a history of T+1 returns at time intervals i, (uncompounded returns over the previous t time steps) comprising the steps of;
a) defining a vector xᵢ of T+1 returns on an asset pᵢ over a historic time period T at time intervals i;
b) select a minimum desired threshold return value r where
w.xᵢ−r+ξᵢ≧0
wherein ξᵢ are positive (non-zero) slack variables reflecting the amount the portfolio w historically fell short of the desired value of r,
c) optimise the problem in step b) by applying the Langrangian function
minimize
$$L = \frac{1}{2} {‖ w ‖}^{2} + \frac{C}{p} {\sum }_{i = 1}^{T} {ξ}_{i}^{p}$$
where ξ^{p} represents the non-zero slack variables of step b) to a power p and C is a weighting constant;
d) transforming the function of c) to the dual Langrangian and solving the quadratic programming problem for dual variables α where p=1 and/or p=2;
e) determining from the solutions to step d), a portfolio w where;
$$w = {\sum }_{i = 1}^{T} {α}_{i} {x}_{i}$$

8. A method as claimed in claim 7 further comprising;
after step a), identifying an overall mean level of return R for portfolio w from the expression
$$\frac{1}{T} {\sum }_{i}^{T} w \cdot {x}_{i} = R$$
and apply in extrapolation of xᵢ according to the expression
xᵢ|→xᵢ+λ−μ
where μ is the mean returns vector (based on R) for the historical price data and λ is the vector of predicted future returns.

9. A method as claimed in claim 7 wherein step d) involves maximising the quadratic equations respectively;
and
$$L = - \frac{1}{2} {\sum }_{i = 1}^{T} {\sum }_{j = 1}^{T} {α}_{i} {α}_{j} {x}_{i} \cdot {x}_{j} + r {\sum }_{i = 1}^{T} {α}_{i}$$
$$and$$
$$L = - \frac{1}{2} {\sum }_{i = 1}^{T} {\sum }_{j = 1}^{T} {α}_{i} {α}_{j} ( {x}_{i} \cdot {x}_{j} + \frac{1}{C} {δ}_{ij} ) + r {\sum }_{i = 1}^{T} {α}_{i}$$
subject to the constraints 0≦αᵢ≦C and
$${\sum }_{i = 1}^{T} {m}_{i} {α}_{i} = 1$$
where mᵢ=xᵢ.1 and αᵢ≧0 and
$${\sum }_{i = 1}^{T} {m}_{i} {α}_{i} = 1$$
where mᵢ=xᵢ.1

10. A program for a computer configured to perform the method of claim 1 based on data input including inter alia data selected from N, p, t, T. and/or C.

11. A computer readable storage media carrying a program as claimed in claim 10.

12. A program configured to perform the method of claim 2 based on input data including inter alia data selected from N, q, t, T and/or C.

13. A computer readable storage media carrying a program as claimed in claim 12.

14. A program configured to perform the method of claim 7 based on input data including inter alia data selected from N, p, t, T, r, x and/or C.

15. A computer readable storage media carrying a program as claimed in claim 14.

16. A system for selecting a portfolio w consisting of N assets, the system comprising;
a computer;
a database accessible by the computer and comprising data including prices pᵢ of a plurality of assets and a history of returns on those assets over a known time period T+1 at time intervals i;
interface means for permitting a user to access the computer and to input data selecting N assets from the database;
software resident on the computer for causing the computer to define a portfolio, the software utilising the method of claim 1;
means for providing to the user a visual representation of the defined portfolio w.

17. A system for selecting a portfolio w consisting of N assets, the system comprising;
a computer;
a database accessible by the computer and comprising data including prices pᵢ of a plurality of assets and a history of returns on those assets over a known time period T+1 at time intervals i;
interface means for permitting a user to access the computer and to input data selecting N assets from the database;
software resident on the computer for causing the computer to define a portfolio, the software utilising the method of claim 2;
means for providing to the user a visual representation of the defined portfolio w.

18. A system for selecting a portfolio w consisting of N assets, the system comprising;
a computer;
a database accessible by the computer and comprising data including prices pᵢ of a plurality of assets and a history of returns on those assets over a known time period T+1 at time intervals i;
interface means for permitting a user to access the computer and to input data selecting N assets from the database;
software resident on the computer for causing the computer to define a portfolio, the software utilising the method of claim 7;
means for providing to the user a visual representation of the defined portfolio w.

19. A system as claimed in claim 16 wherein the database is provided on a server separate from the computer but accessible by the computer via a telecommunications network

20. A system as claimed in claim 19 wherein there is a plurality of computers each having access to the database server via a telecommunications network.

21. A system as claimed in claim 16 wherein the interface means comprises one or more computer peripherals selected from; a keyboard; a computer mouse, tracker ball or touch sensitive panel; a graphical user interface; a touch sensitive display screen; voice recognition technology.

22. A system as claimed in claim 16 wherein the means for providing a visual representation is selected from a printer and/or a display monitor.

23. A system as claimed in claim 17 wherein the database is provided on a server separate from the computer but accessible by the computer via a telecommunications network

24. A system as claimed in claim 23 wherein there is a plurality of computers each having access to the database server via a telecommunications network.

25. A system as claimed in claim 17 wherein the interface means comprises one or more computer peripherals selected from; a keyboard, a computer mouse, tracker ball or touch sensitive panel; a graphical user interface; a touch sensitive display screen; voice recognition technology.

26. A system as claimed in claim 17 wherein the means for providing a visual representation is selected from a printer and/or a display monitor.

27. A system as claimed in claim 18 wherein the database is provided on a server separate from the computer but accessible by the computer via a telecommunications network

28. A system as claimed in claim 27 wherein there is a plurality of computers each having access to the database server via a telecommunications network.

29. A system as claimed in claim 18 wherein the interface means comprises one or more computer peripherals selected from; a keyboard; a computer mouse, tracker ball or touch sensitive panel; a graphical user interface; a touch sensitive display screen; voice recognition technology.

30. A system as claimed in claim 18 wherein the means for providing a visual representation is selected from a printer and/or a display monitor.
